(19) United States
(12) Patent Application Publication
(10) Pub. No.: US 2011/0086752 A1
(43) Pub. Date: Apr. 14, 2011

(54) DYNAMICALLY BALANCED CHAMBER FOR CENTRIFUGAL SEPARATION OF BLOOD

(76) Inventor: Mark J. Brierton, Cary, IL (US)

(21) Appl. No.: 12/575,683

(22) Filed: Oct. 8, 2009

(51) Int. Cl. B04B 9/14

(52) U.S. Cl. 494/82

(57) ABSTRACT

A blood separation chamber for rotation about an axis comprises a low-G wall and a high-G wall extending about the axis in a spaced apart relationship to define between them a separation channel. The separation channel includes axially spaced first and second ends. The first end of the separation channel defines at least one generally arcuate recessed region and at least one radial wall within the recessed region sized and positioned so as to aid in balancing the blood separation chamber during rotation about the axis.

### BACKGROUND

1. Field of the Disclosure

The present subject matter relates to a chamber for centrifugal separation of blood into various components.

2. Description of Related Art

Whole blood is routinely separated into its various components, such as red blood cells, platelets, and plasma. Conventional blood processing methods use durable centrifuge equipment in association with single use, sterile processing systems, typically made of plastic. The operator assembles the disposable systems in association with the centrifuge, and connects the donor or patient.

One element of a typical disposable system used in centrifugal processing is a blood processing chamber, which is associated with a centrifuge for rotation about a central axis of the chamber. An exemplary blood processing chamber A is illustrated in FIGS. 1-3. The chamber A and similar chambers are described in greater detail in U.S. Pat. Nos. 6,348,156; 6,875,191; 7,011,761; 7,087,177; and 7,297,272 and U.S. Patent Application Publication No. 2005/0137516, which are hereby incorporated herein by reference.

The chamber A includes a channel B defined between an inner low-G wall C and an outer high-G wall D. In use, blood flows into the channel B via an inlet E. The chamber A is rotated about its central axis, and the blood separates into its various components (e.g., plasma and red cells) as it travels from the inlet E to one of the outlets F of the channel B. A barrier G may be positioned in the vicinity of the outlets F to allow accumulation of platelets in the channel B during selected procedures.

It is beneficial for the chamber A to be properly balanced during rotation about the axis, otherwise it may unduly vibrate, create undesirable perturbations in fluid flow, or otherwise cause excess wear or function improperly. A number of factors may be considered when dynamically balancing the chamber A, including the presence of fluid in the channel B during rotation and the additional weight added to a portion of the chamber A by the barrier G. Taking these factors into account, in the illustrated prior art chamber A, the low-G wall C has a non-uniform radial thickness with a region H of greatest thickness positioned at a selected angular location so as to aid in balancing the chamber A during rotation about the axis. In particular, the thickened region H is positioned generally opposite the inlet E, outlets F, and barrier G of the channel B.

While the design illustrated in FIGS. 1-3 has proven to be effective in balancing the chamber A during blood separation, the thickened region H can be more difficult to manufacture or lead to inefficiencies. For example, the chamber A is made using an injection-molding process, and the thickened region H acts as a limiting factor, because it requires more plastic material than the remainder of the low-G wall C and it takes longer to solidify during manufacturing.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a blood separation chamber for rotation about an axis comprises a low-G wall and a high-G wall extending about the axis in a spaced apart relationship to define between them a separation channel. The separation channel includes an inlet for flowing blood into the channel, at least one outlet for removing a blood component from the channel, and has axially spaced first and second ends. The first end defines at least one generally arcuate recessed region and at least one radial wall within the recessed region sized and positioned so as to aid in balancing the blood separation chamber during rotation about the axis.

In another separate aspect, a blood separation chamber for rotation about an axis comprises a low-G wall and a high-G wall extending about the axis in a spaced apart relationship to define between them a separation channel. The separation channel includes axially spaced first and second ends, the first end defining at least one generally arcuate recessed region and at least one radial wall within the recessed region. A central hub is aligned with the axis and a rib extends between the central hub and the low-G wall. The radial wall is sized and positioned so as to aid in balancing the blood separation chamber during rotation about the axis.

In yet another separate aspect, a blood separation chamber for rotation about an axis comprises a low-G wall and a high-G wall extending about the axis in a spaced apart relationship to define between them a separation channel. The separation channel includes an inlet for flowing blood into the channel, at least one outlet for removing a blood component from the channel, and axially spaced first and second ends. The first end of the channel defines a plurality of alternating recessed regions and radial walls. A central hub is aligned with the axis and a plurality of ribs extend between the central hub and the low-G wall. One of the ribs is substantially angularly aligned with the inlet and/or the outlet, another rib is angularly offset from the inlet and the outlet, and each rib is positioned generally opposite at least one of the radial walls.

### BRIEF DESCRIPTION OF THE DRAWINGS

FIG. 1 is a top plan view of a known prior art blood processing chamber;

FIG. 2 is a bottom plan view of the blood processing chamber shown in FIG. 1;

FIG. 3 is a cross-sectional view of the blood processing chamber shown in FIG. 2, taken through the line 3-3 of FIG. 2;

FIG. 4 is a top plan view of a blood processing chamber according to the present disclosure;

FIG. 5 is a bottom plan view of the blood processing chamber shown in FIG. 4;

FIG. 6 is a cross-sectional view of the blood processing chamber shown in FIG. 4;

FIG. 7 is a bottom perspective view of the blood processing chamber shown in FIG. 4;

FIG. 8 is a top perspective view of the blood processing chamber shown in FIG. 4, including a lid overlaying an open end of the separation channel of the chamber;

FIG. 9 is a top plan view of another embodiment of a blood processing chamber according to the present disclosure;

FIG. 10 is a bottom plan view of the blood processing chamber shown in FIG. 9; and

FIG. 11 is a bottom perspective view of the blood processing chamber shown in FIG. 9.

### DESCRIPTION OF THE ILLUSTRATED EMBODIMENTS

The embodiments disclosed herein are for the purpose of providing the required description of the present subject matter. They are only exemplary, and may be embodied in various forms. Therefore, specific details disclosed herein are not to be interpreted as limiting the subject matter as defined in the accompanying claims.

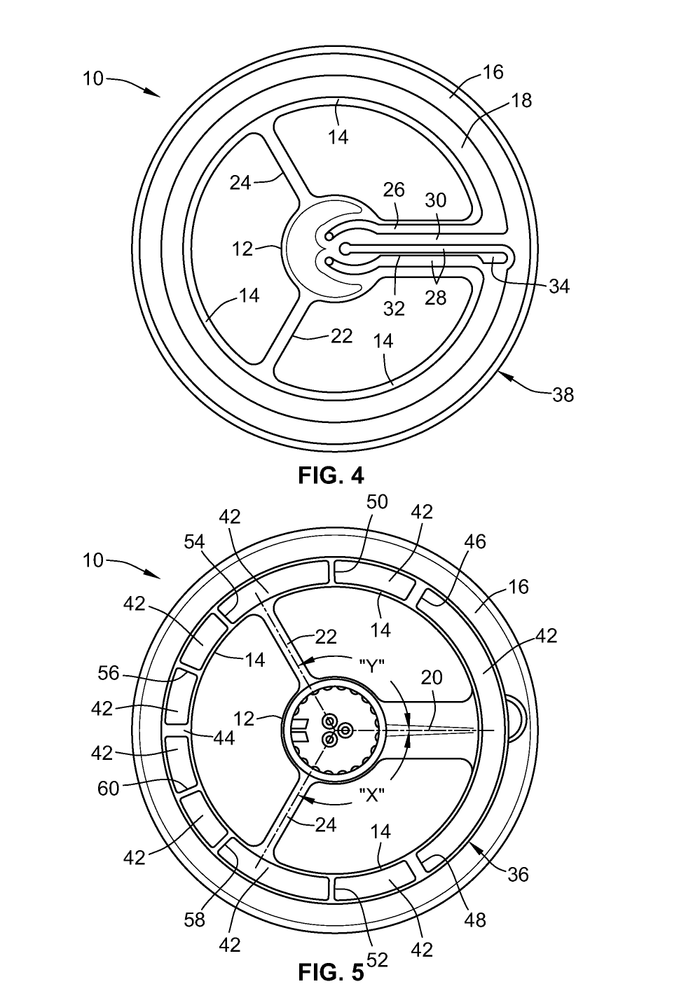

The principles described herein may be incorporated into various blood separation chambers and employed in a variety of blood processing systems and blood separation procedures. As the principles described herein may be employed with a variety of chambers, blood processing systems, and procedures, it should be understood that the chambers described herein are merely exemplary. Further, the exact manner of associating a chamber with a centrifuge station and specific procedures employing a chamber according to the present disclosure will not be described in detail herein. Those of ordinary skill in the art will understand how to incorporate a chamber into a blood processing system, associate the chamber with a centrifuge station, and use the chamber and centrifuge station to carry out a variety of blood separation procedures. However, while the principles described herein may be employed with a variety of chambers, systems, and procedures, the chambers illustrated in FIGS. 4-11 are particularly well suited for use in combination with the systems and procedures generally described in U.S. Pat. Nos. 6,348,156; 6,875,191; 7,011,761; 7,087,177; and 7,297,272 and U.S. Patent Application Publication No. 2005/0137516 and may be embodied in the ALYX® blood processing systems marketed by Fenwal, Inc. of Lake Zurich, Ill.

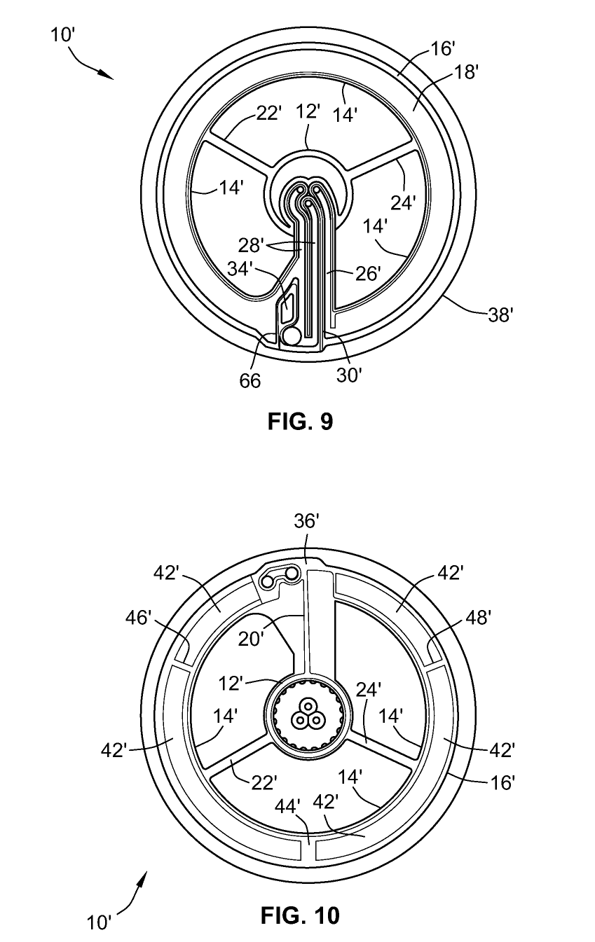

FIGS. 4-8 show an embodiment of a blood separation chamber 10 that embodies various aspects of the present subject matter. FIGS. 9-11 illustrate another embodiment of a blood separation chamber 10′ embodying various aspects of the present subject matter and will be described in greater detail later.

The chamber 10 of FIGS. 4-8, includes a central hub 12 which is aligned with the central axis of the chamber 10. The hub 12 is surrounded by an inner or low-G wall 14 and an outer or high-G wall 16. The low-G and high-G walls 14 and 16 are spaced apart from each other to define between them a separation channel 18. In the illustrated embodiment, the low-G wall 14 and the high-G wall 16 are substantially annular, thereby defining a substantially annular channel 18.

The contours, ports, channels, and walls that are formed in the chamber 10 can vary. In the embodiment shown in FIGS. 4-8, angularly spaced stiffening ribs 20, 22, and 24 (FIG. 5) extend between the hub 12 and the low-G wall 14. The ribs 20, 22, and 24 provide rigidity to the chamber 10.

In the illustrated embodiment, one of the ribs 20 is substantially angularly aligned with an inlet 26 and a pair of outlets 28 of the channel 18, while the other ribs 24 and 22 are angularly offset by angles “X” and “Y,” respectively, from the inlet 26 and the outlets 28. The inlet 26 extends from the central hub 12 to the channel 18 for flowing blood into the channel 18 in an exemplary flow condition. The outlets 28 also extend from the central hub 12 to the channel 18, but operate to remove a separated blood component from the channel 18 in an exemplary flow condition. In other flow conditions, the flow path labeled as inlet 26 may be used to remove a separated blood component from the channel 18 while one of the flow paths labeled as outlet 28 may allow blood inflow to the channel 18.

In this embodiment (as FIG. 4 shows), a terminal wall 30 extends from the central hub 12 and crosses the entire channel 18 to join the high-G wall 16. The terminal wall 30 forms a terminus in the channel 18 and separates the inlet 26 from the outlets 28, thereby forcing blood and separated blood components to flow completely around the channel 18 from the inlet 26 to the outlets 28.

FIG. 4 shows another wall 32 extending from the central hub 12 into the channel 18, although the wall 12 does not join the high-G wall 16. Instead, this wall 32 is positioned between the outlets 28 and includes a barrier 34, which is thicker (in an annular direction) than the wall 32 itself. For certain procedures, the barrier 34 allows accumulation of a separated blood component (e.g., platelets) in the channel 18. The barrier 34 (if provided) adds weight to the associated region of the chamber 10, so it is a factor to potentially be considered when taking steps to dynamically balance the chamber 10.

The chamber 10 and the channel 18, in the illustrated orientation, extend between a first or lower end 36 and a second or upper end 38, with the first and second ends 36 and 38 being axially spaced from each other. The first end 36 is substantially closed to define the bottom of the channel 18, while the second end 38 is substantially open. The second end 38 is substantially closed by a separately molded, flat lid 40 (FIG. 8). During assembly, the lid 40 is secured to the second end 38, e.g., by use of a cylindrical sonic welding horn. The illustrated lid 40 will be described in greater detail later.

Turning now to the first end 36, it is illustrated in more detail in FIGS. 5-7. The first end 36 defines at least one and preferably a plurality of generally arcuate recessed regions 42 and at least one radial wall 44. As used herein, the term “recessed region” may either refer to an individual recessed portion of the first end 36 between adjacent radial walls (such that the recessed regions 42 and radial walls are alternately spaced along the first end 36) or collectively reference two or more of the various recessed portions (such that each radial wall is positioned within the collective (substantially arcuate or annular) recessed portion of the first end 36).

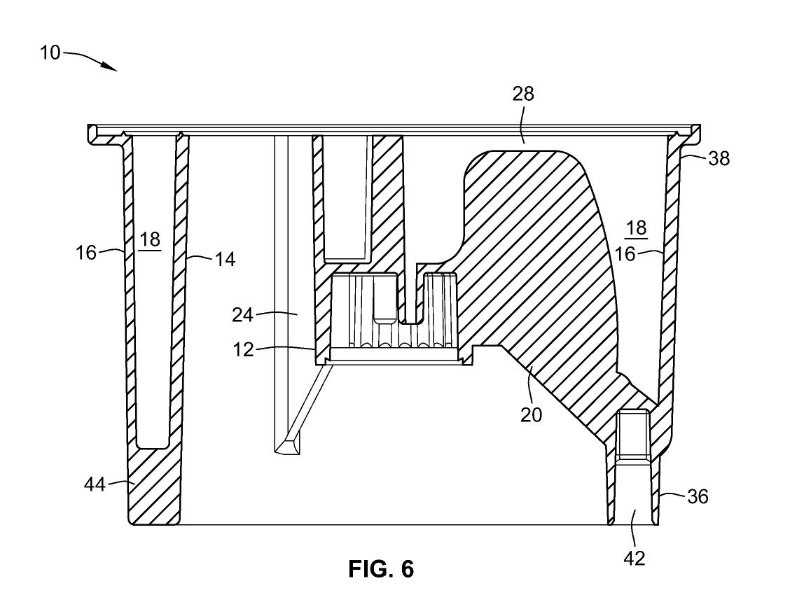

FIG. 6 shows that the first end 36 of the channel 18 in cross-section, illustrating a recessed region 42 and a radial wall 44. On account of the different location of material spaced throughout the first end 36 of the channel 18, it will be understood that the portions of the first end 36 having a radial wall will be heavier than the portions having only a recessed region. Accordingly, a chamber employing the principles described herein will be differently balanced depending on the positioning, size, and configuration of the various recessed regions and radial walls, meaning that it can be customized depending on the particular configuration of the channel and chamber and the expected method of using the chamber. Typically, the desired channel configuration may be selected and then the first end (including the recessed regions and radial walls) may be designed so as to aid in balancing the chamber during rotation about its axis.

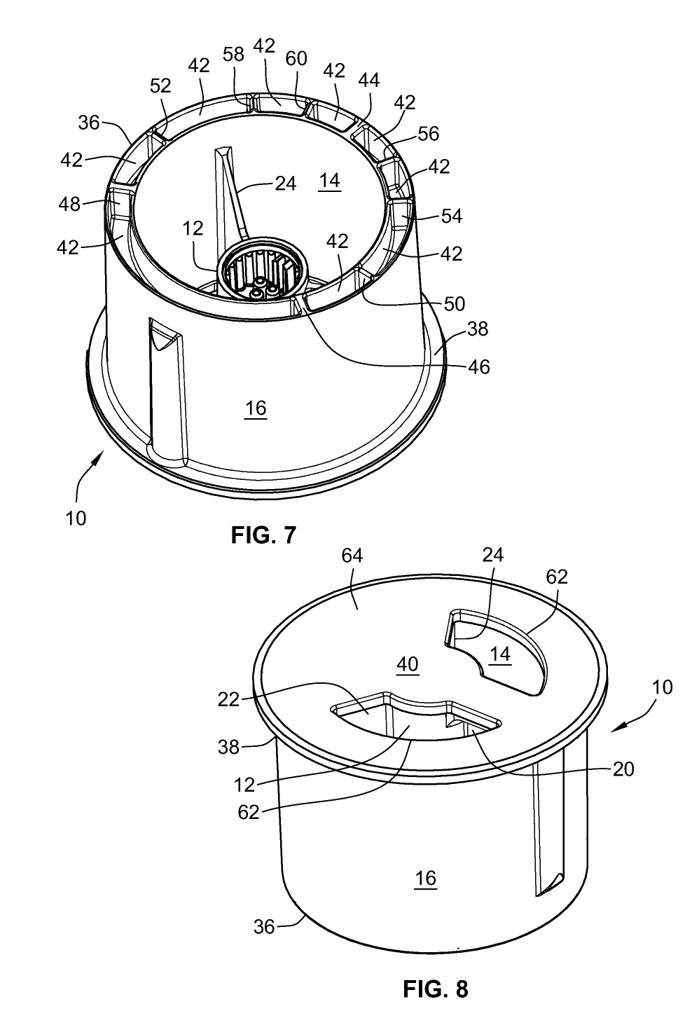

FIGS. 5 and 7 illustrate a particular configuration with a plurality of radial walls and recessed regions 42. Selected radial walls 44, 46, and 48 are positioned approximately 120° from each other and oriented generally opposite one of the stiffening ribs 20, 22, and 24. One of the radial walls 44 is also positioned generally opposite the inlet 26, the outlets 28, and the barrier 34, while the other radial walls 46 and 48 are angularly offset from the inlet 26 and the outlets 28. In the illustrated embodiment, the radial walls 44, 46, and 48 are thicker in the annular direction than the other radial walls, which may be advantageous for providing additional weight to counterbalance the ribs 20, 22, and 24. In the case of radial wall 44, it further assists to counterbalance the inlet 26, outlets 28, and the barrier 34 of the channel 18. Further, in one manufacturing method, the chamber 10 is a unitarily molded plastic piece and the relatively thick radial walls 44, 46, and 48 correspond to the locations in which plastic enters into the mold. Therefore, when employing such a manufacturing method, it may be advantageous for such radial walls 44, 46, and 48 to be relatively large to allow increased inflow of plastic into the mold.

The other radial walls 50, 52, 54, 56, 58, and 60 are variously positioned about the first end 36 of the channel 18 to aid in balancing the chamber 10 during rotation about the axis. All of these radial walls 50, 52, 54, 56, 58, and 60 are angularly offset from all of the ribs 20, 22, and 24, with radial walls 56 and 60 being generally opposite rib 20 (i.e., angularly offset generally 180° from rib 20). Two of the radial walls 50 and 52 are each positioned approximately 90° from the inlet 26 and the outlets 28, opposite each other. Two of the other four ribs 54 and 56 are positioned between ribs 44 and 50, with rib 54 being positioned approximately halfway between ribs 44 and 50 and rib 56 being positioned approximately halfway between ribs 44 and 54. The remaining two ribs 58 and 60 are positioned between ribs 44 and 52, with rib 58 being positioned approximately halfway between ribs 44 and 52 and rib 60 being positioned approximately halfway between ribs 44 and 58. Hence, it will be seen that the first end 36 of the channel 18 is substantially symmetrical about a line passing through rib 20 and radial wall 44.

Returning now to the lid 40 (FIG. 8), it comprises a single flat piece that can be welded or otherwise secured to the remainder of the chamber 10 to overlie the second end 38 of the channel 18, thereby closing the channel 18. In one embodiment, the lid 40 may be comprised of the same material as the remainder of the chamber 10. The illustrated lid 40 defines at least one open section 62 and at least one closed section 64. The ribs 20, 22, and 24 of the chamber 10 can be seen in FIG. 8, with the space between adjacent ribs 20 and 22 aligned with an open section 62, the space between adjacent ribs 20 and 24 aligned with another open section 62, and the space between adjacent ribs 22 and 24 is aligned with the closed section 64. It will be understood that the closed section 64 weighs more than the open sections 62, so the configuration of the lid 40 (particularly the arrangement of the closed and open sections) may be modified to customize the weight distribution of the lid 40. The weight distribution of the lid 40 will affect the dynamic balance of the chamber 10, so the configuration of the lid 40 may be modified so as to aid in balancing the chamber 10 during rotation about the axis. In the illustrated embodiment, the closed section 64 is positioned generally opposite rib 20 and, hence, the inlet 26 and outlets 28 of the channel 18; however, this configuration is merely exemplary and other lid configurations may also be employed without departing from the scope of the present disclosure.

As for the chamber 10′ of FIGS. 9-11, it is similar to the chamber 10 and includes several corresponding components. The components of chamber 10′ generally corresponding to elements of chamber 10 are identified by the same reference numeral prime (e.g., the chamber 10′ itself generally corresponds to the chamber 10 of FIGS. 4-8). The components of chamber 10′ conform to the above description of the corresponding components of chamber 10 except where noted to the contrary below.

The chamber 10′ includes a central hub 12′ which is aligned with the central axis of the chamber 10′. The hub 12′ is surrounded by an inner or low-G wall 14′ and an outer or high-G wall 16′, which walls are spaced apart from each other to define between them a separation channel 18′. In the embodiment illustrated in FIGS. 9-11, the low-G wall 14′ and the high-G wall 16′ are substantially annular, thereby defining a substantially annular channel 18′.

As best illustrated in FIG. 10, angularly spaced stiffening ribs 20′, 22′, and 24′ extend between the hub 12′ and the low-G wall 14′. One rib 20′ is substantially angularly aligned with an inlet 26′ and a pair of outlets 28′ of the channel 18′, while the other ribs 22′ and 24′ are angularly offset from the inlet 26′ and the outlets 28′. The inlet 26′ and outlets 28′ are differently configured from the inlet 26 and outlets 28 shown in FIG. 4, but perform the same function of allowing blood to flow into the channel 18′ and removing a separated blood component from the channel 18′, respectively, in an exemplary flow condition. In other flow conditions, the inlet 26′ may be used to remove a separated blood component from the channel 18′ while one of the outlets 28′ allows blood flow into the channel 18′.

A terminal wall 30′ extends from the central hub 12′ and crosses the entire channel 18′ to join the high-G wall 16′. Similar to the terminal wall 30 of FIG. 4, the terminal wall 30′ forms a terminus in the channel 18′ and separates the inlet 26′ from the outlets 28′, thereby forcing blood and separated blood components to flow completely around the channel 18′ from the inlet 26′ to the outlets 28′.

Another wall 66 extends from the high-G wall 16′ into the channel 18′ (FIG. 9), although the wall 66 does not join the low-G wall 14′ or the central hub 12′. The wall 66 is positioned between the outlets 28′ and includes a barrier 34′, which is wider (in an angular direction) than the wall 66 itself. Similar to the barrier 34 of FIG. 4, the barrier 34′ allows accumulation of a separated blood component (e.g., platelets) in the channel 18′. It also results in added weight to the associated region of the chamber 10′ which should be considered when taking steps to dynamically balance the chamber 10′.

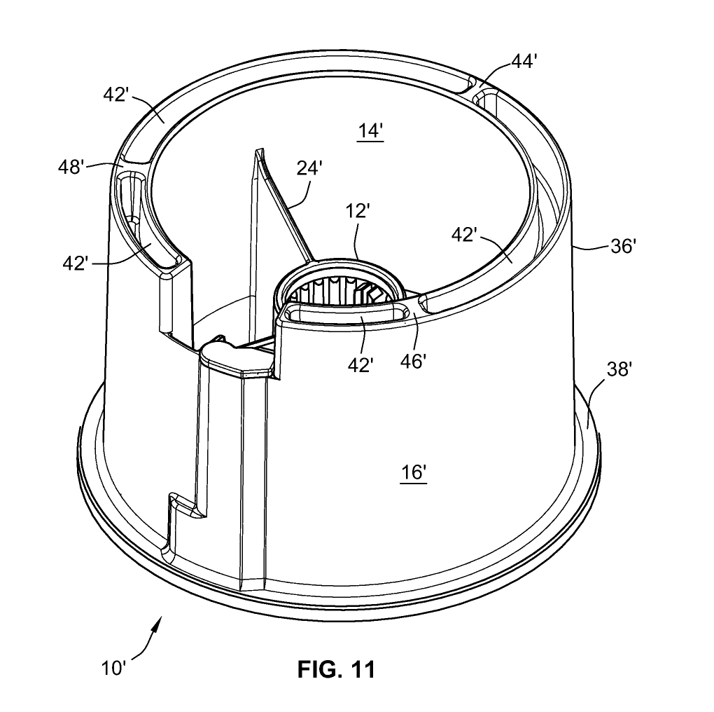

The chamber 10′ and channel 18′ extend between a first or lower end 36′ (FIGS. 10 and 11) and a second or upper end 38′ (FIGS. 9 and 11) which are axially spaced from each other. The first end 36′ is substantially closed to define the bottom of the channel 18′, while the second end 38′ is substantially open. The second end 38′ is substantially closed by a separate lid, which may correspond generally to the lid 40 of FIG. 8.

As seen in FIGS. 10 and 11, the first end 36′ defines at least one generally arcuate recessed region 42′ and at least one radial wall 44′. In the illustrated embodiment, the first end 36′ includes three radial walls 44′, 46′, and 48′ which are positioned approximately 120° from each other and oriented generally opposite (at a 180° angle from) one of the stiffening ribs 20′, 22′, and 24′. One of the radial walls 44′ is also positioned generally opposite the inlet 26′, the outlets 28′, and the barrier 34′, while the other radial walls 22′ and 24′ are angularly offset from the inlet 26′ and the outlets 28′. In contrast to the first end 36 of FIGS. 5 and 7, the first end 36′ of FIGS. 10 and 11 does not include any radial walls in addition to the three that are positioned opposite the stiffening ribs 20′, 22′, and 24′. Hence, the principles described herein may be employed in varying ways, as illustrated in FIGS. 10 and 11, for example, or as illustrated in FIGS. 5 and 7, depending on the nature of the chamber, the intended use of the chamber, and other factors.

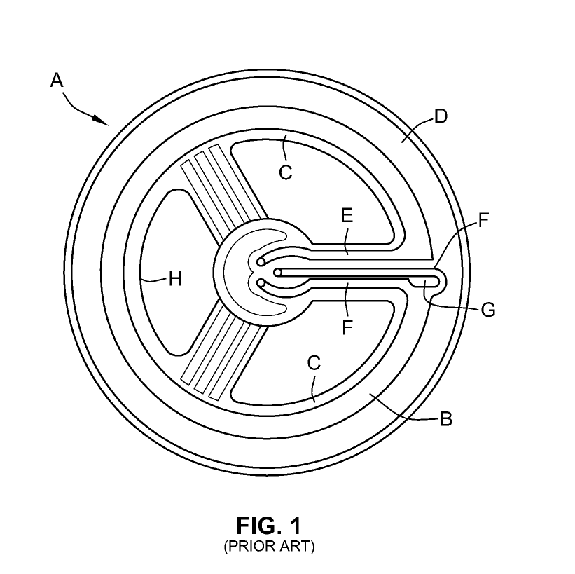

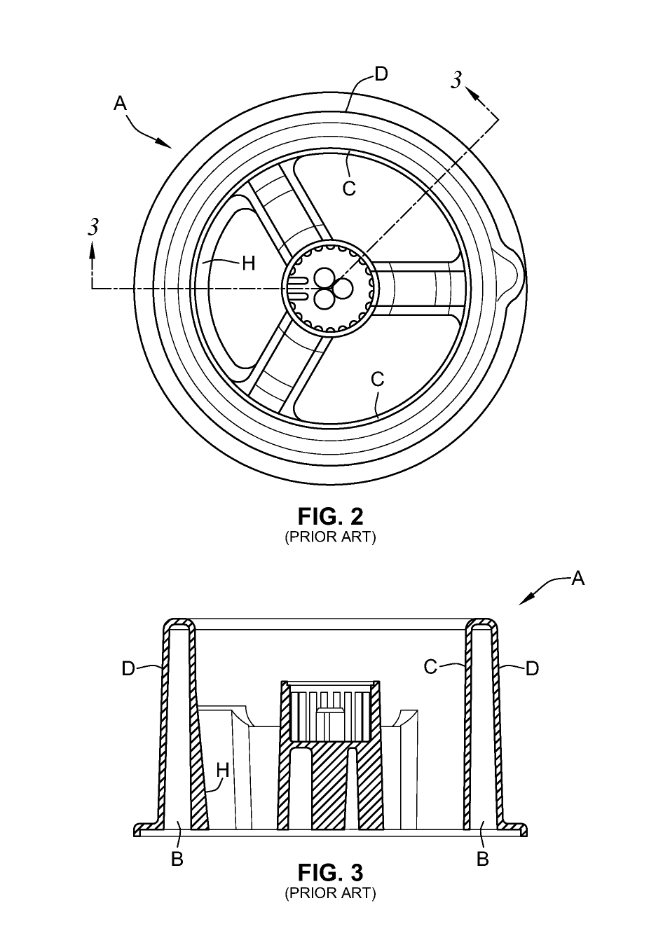

In addition to there being advantages reflected in a balanced chamber during a blood separation procedure, chambers according to the foregoing description also have manufacturing benefits. The chambers 10 and 10′ may be unitarily formed in a desired shape and configuration, e.g., by injection molding, from a rigid, biocompatible plastic material, such as a non-plasticized medical grade acrylonitrile-butadiene-styrene (ABS). As described above with regard to the prior art chamber A of FIGS. 1-3, one known method of balancing the chamber A is to provide a low-G wall C with a relatively thick region H, which requires more plastic material than the remainder of the low-G wall C, so it takes longer to solidify during molding. As the low-G walls 14 and 14′ of chambers 10 and 10′ lack the thickened region H of the prior art chamber A, all portions of the respective low-G walls will solidify at substantially the same rate, thereby avoiding the above-described manufacturing inefficiency. Also, the recessed regions and radial walls at the first end of the channel provide a gripping surface, which may be useful during manufacturing for holding the chamber in a desired angular orientation.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims.

1. A blood separation chamber for rotation about an axis, comprising:
a low-G wall and a high-G wall extending about the axis in a spaced apart relationship to define between them a separation channel, the separation channel including
an inlet for flowing blood into the separation channel, and
at least one outlet for removing a blood component from the separation channel, and
axially spaced first and second ends, the first end defining at least one generally arcuate recessed region and at least one radial wall within the recessed region sized and positioned so as to aid in balancing the blood separation chamber during rotation about the axis.

2. The blood separation chamber of claim 1, wherein said radial wall is positioned generally opposite the inlet and/or outlet of the separation channel.

3. The blood separation chamber of claim 1, wherein the radial wall is unitarily formed with the first end of the separation channel.

4. The blood separation chamber of claim 1, further comprising
an additional radial wall, said radial walls being separated from each other by said recessed region;
a central hub aligned with the axis;
a rib extending between the central hub and the low-G wall, said rib being substantially angularly aligned with the inlet and/or the outlet of the separation channel and positioned generally opposite said radial walls.

5. The blood separation chamber of claim 1, further comprising
a central hub aligned with the axis;
a rib extending between the central hub and the low-G wall, said rib being angularly offset from the inlet and the outlet of the separation channel and positioned generally opposite said radial wall.

6. The blood separation chamber of claim 1, further comprising a plurality of alternating recessed regions and radial walls unitarily formed with the first end of the separation channel.

7. The blood separation chamber of claim 6, further comprising
a central hub aligned with the axis; and
a plurality of ribs extending between the central hub and the low-G wall, wherein one of said ribs is substantially angularly aligned with the inlet and/or the outlet of the separation channel, another rib is angularly offset from the inlet and the outlet, and each rib is positioned generally opposite at least one of said radial walls.

8. The blood separation chamber of claim 1, further comprising a lid overlaying the second end of the separation channel, wherein the lid includes at least one open section and at least one closed section, wherein the closed section is positioned generally opposite the inlet and/or the outlet of the separation channel and configured so as to aid in balancing the blood separation chamber during rotation about the axis.

9. A blood separation chamber for rotation about an axis, comprising:
a low-G wall and a high-G wall extending about the axis in a spaced apart relationship to define between them a separation channel, the separation channel including axially spaced first and second ends, the first end defining at least one generally arcuate recessed region and at least one radial wall within the recessed region;
a central hub aligned with the axis; and
a rib extending between the central hub and the low-G wall, wherein said radial wall is sized and positioned so as to aid in balancing the blood separation chamber during rotation about the axis.

10. The blood separation chamber of claim 9, wherein the radial wall is unitarily formed with the first end of the separation channel.

11. The blood separation chamber of claim 9, wherein
the separation channel includes an inlet and at least one outlet,
the rib is substantially angularly aligned with inlet and/or the outlet, and
the radial wall is positioned generally opposite the rib, the inlet, and/or the outlet.

12. The blood separation chamber of claim 11, further comprising a lid overlaying the second end of the separation channel, wherein the lid includes at least one open section and at least one closed section, wherein the closed section is positioned generally opposite the inlet and/or the outlet of the separation channel and configured so as to aid in balancing the blood separation chamber during rotation about the axis.

13. The blood separation chamber of claim 9, wherein the radial wall is positioned generally opposite the rib.

14. The blood separation chamber of claim 13, wherein the separation channel includes an inlet and at least one outlet and the first end of the separation channel includes an additional radial wall, the additional radial wall being positioned generally opposite the inlet and/or the outlet.

15. The blood separation chamber of claim 9, further comprising a plurality of alternating recessed regions and radial walls unitarily formed with the first end of the separation channel.

16. The blood separation chamber of claim 15, further comprising an additional rib extending between the central hub and the low-G wall, wherein
the separation channel includes an inlet and at least one outlet,
one of the ribs is substantially angularly aligned with the inlet and/or the outlet,
the other rib is angularly offset from the inlet and the outlet, and
each rib is positioned generally opposite at least one of said radial walls.

17. A blood separation chamber for rotation about an axis, comprising:
a low-G wall and a high-G wall extending about the axis in a spaced apart relationship to define between them a separation channel, the separation channel including
an inlet for flowing blood into the separation channel, and
at least one outlet for removing a blood component from the separation channel, and
axially spaced first and second ends, the first end defining a plurality of alternating recessed regions and radial walls;
a central hub aligned with the axis; and
a plurality of ribs extending between the central hub and the low-G wall, wherein
one of said ribs is substantially angularly aligned with the inlet and/or the outlet,
another rib is angularly offset from the inlet and the outlet, and
each rib is positioned generally opposite at least one of said radial walls.

18. The blood separation chamber of claim 17, wherein said plurality of alternating recessed regions and radial walls are unitarily formed with the first end of the separation channel.

19. The blood separation chamber of claim 17, wherein at least one of said radial walls is not positioned generally opposite any of said ribs.

20. The blood separation chamber of claim 17, further comprising a lid overlaying the second end of the separation channel, the lid including at least one open section and at least one closed section, wherein the closed section is positioned generally opposite the inlet and/or the outlet of the separation channel and configured to aid in balancing the blood separation chamber during rotation about the axis.
